(19) United States
(12) Patent Application Publication
(10) Pub. No.: US 2004/0072027 A1
(43) Pub. Date: Apr. 15, 2004

(54) Intermediate layer for perpendicular magnetic recording media

(75) Inventors: Bin Lu, Franklin Park, PA (US); Dieter K. Weller, Gibsonia, PA (US)

Correspondence Address: BRINKS HOFER GILSON & LIONE, P.O. BOX 10395, CHICAGO, IL, 60611, US

(73) Assignee: Seagate Technology LLC, Scotts Valley, CA

(21) Appl. No.: 10/447,642

(22) Filed: May 29, 2003

Related U.S. Application Data
(60) Provisional application No. 60/414,727, filed on Sep. 30, 2002.

(51) Int. Cl. G11B 5/66

(52) U.S. Cl. 428/694 R; 428/694 TS

(57) ABSTRACT

A perpendicular magnetic recording medium includes a hard magnetic recording layer, a soft magnetic layer and a non-magnetic intermediate layer between the hard magnetic recording layer and the soft magnetic layer. The non-magnetic intermediate layer comprises a seedlayer formed adjacent the soft magnetic layer and an underlayer formed between the seedlayer and hard magnetic recording layer. The underlayer comprises Ru or CrRu. The seedlayer comprises CoCrRu, CoCr, W, Ta, Mo, Hf, or Ti. The non-magnetic intermediate layer provides a means for inducing a substantially (00.2) orientation in the hard magnetic recording layer.

### CROSS REFERENCE TO RELATED APPLICATION

This application claims the benefit of U.S. Provisional Application No. 60/414,727 filed Sep. 30, 2002.

### FIELD OF THE INVENTION

The invention relates to magnetic recording systems, and more particularly, relates to an intermediate layer for perpendicular magnetic recording media.

### BACKGROUND OF THE INVENTION

Perpendicular magnetic recording systems have been developed for use in computer hard disc drives. Perpendicular recording designs have the potential to support much higher linear densities than conventional longitudinal designs due to, for example, a reduced demagnetizing field in the recording transitions.

A typical perpendicular recording head may include a trailing write pole, a leading return or opposing pole magnetically coupled to the write pole, and an electrically conductive magnetizing coil surrounding the yoke of the write pole. A perpendicular recording medium may include a hard magnetic recording layer with vertically oriented magnetic grains and a soft magnetic layer (sometimes referred to as a soft underlayer) to provide increased writing efficiency of the recording head. Such perpendicular recording medium may also include an intermediate or interlayer between the hard magnetic recording layer and the soft magnetic layer. A protective overcoat layer and/or a lubricant layer may be formed on the hard magnetic recording layer, as is generally known.

During a write operation, the perpendicular magnetic recording medium is moved past the perpendicular magnetic recording head so that the recording head follows the tracks of the recording medium, with the recording medium first passing under the opposing pole and then passing under the write pole. Current is passed through the coil to create magnetic flux within the write pole. The magnetic flux passes from the write pole tip, through the hard magnetic recording layer, into the soft magnetic layer, and across to the opposing pole. The soft magnetic layer forms inverse image charges and substantially magnifies the write field during recording.

In addition, the soft magnetic layer helps during the read operation. For example, during the read back process the soft underlayer produces the image of magnetic charges in the hard magnetic recording layer, effectively increasing the magnetic flux coming from the medium. This provides a higher read back signal.

An objective in developing a perpendicular magnetic recording medium is to achieve a thermally stable medium with enhanced signal-to-noise ratio (SNR). The requirements for achieving this objective include, for example, the following: suitable microstructure such as a well defined (00.2) orientation, small grain size and narrow grain size distribution, low face centered cubic (fcc) phase content and low stacking fault density. Additional requirements include magnetic properties such as, for example, the following: sufficient magnetic anisotropy (Kᵤ) and coercivity (H_{c}), an anisotropy field (Hk) compatible with write fields, high negative nucleation field (Hₙ), full remanence squareness and optimized inter-granular exchange interaction. Although these requirements are similar to the requirements for other types of media, such as longitudinal media, the approaches are different due to differences in crystallographic orientation and layer construction. For example, in a perpendicular magnetic recording medium formed of a Co alloy material, crystalline grains are oriented with the c-axes (i.e., the magnetic easy axis direction) in a direction normal to the planes of the films that form the medium. The intrinsic perpendicular anisotropy energy needs to be larger than the demagnetization energy, which typically requires a low stacking fault density.

In order to concentrate the write flux and increase the field gradient, it is important to minimize the distance between an air-bearing surface of the recording head and the soft magnetic layer. This requires that the intermediate layer, which is between the hard magnetic recording layer and the soft magnetic layer, be as thin as possible. It also requires that the hard magnetic recording layer be as thin as possible. However, in the case of a Co alloy hard magnetic recording layer, it is very difficult to achieve a well defined (00.2) orientation of the Co alloy on top of a very thin intermediate layer due to, for example, selective grain growth at the early stage of the film growth. In addition, since stacking fault density and fcc grains tend to concentrate in the initial growth region of the Co alloy film, it is difficult to fabricate the thin and substantially defect-free hard magnetic recording layer.

There is identified a need for an improved perpendicular magnetic recording medium that overcomes limitations, disadvantages, or shortcomings of known perpendicular magnetic recording medium.

### SUMMARY OF THE INVENTION

The invention meets the identified need, as well as other needs, as will be more fully understood following a review of this specification and drawings.

In accordance with an aspect of the invention, a perpendicular magnetic recording medium comprises a hard magnetic recording layer, a soft magnetic layer and a non-magnetic intermediate layer between the hard magnetic recording layer and the soft magnetic layer. The non-magnetic intermediate layer comprises a seedlayer formed adjacent the soft magnetic layer and an underlayer formed between the seedlayer and the hard magnetic recording layer. The underlayer comprises Ru or CrRu. The seedlayer comprises CoCrRu, CoCr, W, Ta, Mo, Hf or Ti. The seedlayer may have a thickness in the range of about 1 nm to about 10 nm. In addition, the underlayer may have a thickness in the range of about 1 nm to about 10 nm.

In accordance with yet another aspect of the invention, a magnetic disc drive storage system comprises a magnetic recording head having an air-bearing surface and a perpendicular magnetic recording medium positioned adjacent the air-bearing surface of the magnetic recording head. The recording medium comprises a hard magnetic recording layer, a soft magnetic layer, and a non-magnetic intermediate layer between the hard magnetic recording layer and the soft magnetic layer. The distance between the air-bearing surface of the magnetic recording head and the soft magnetic layer is in the range of about 10 nm to about 60 nm.

In accordance with another aspect of the invention, a thin film structure comprises a first magnetic layer, a second magnetic layer, and a non-magnetic intermediate layer therebetween. The non-magnetic intermediate layer includes means for inducing a substantially (00.2) orientation in the first magnetic layer. The means for inducing a substantially (00.2) orientation includes a seedlayer formed adjacent the second magnetic layer, wherein the seedlayer has a substantially hexagonally closed packed crystallographic structure. The means for inducing a substantially (00.2) orientation further includes an underlayer formed between the seedlayer and the first magnetic layer, wherein the underlayer has a substantially hexagonally closed packed crystallographic structure.

### BRIEF DESCRIPTION OF THE DRAWINGS

FIG. 1 is a pictorial representation of a disc drive that may utilize a perpendicular recording medium in accordance with the invention.

FIG. 2 is a partially schematic side view of a perpendicular magnetic recording head and a perpendicular recording magnetic medium in accordance with the invention.

FIG. 3 is a schematic side view of a perpendicular recording magnetic medium in accordance with the invention.

FIG. 4 illustrates a full width at half maximum (FWHM) of X-ray diffraction rocking curve and coercivity (H_{c}) of a magnetic recording layer versus a varying thickness seedlayer formed of CoCrRu.

FIG. 5 illustrates a cross-section view of a transmission electron microscopy (TEM) image of a recording medium constructed in accordance with the invention.

FIG. 6 illustrates a cross-section view of a high resolution TEM image showing atomic positions and stacking in a recording medium constructed in accordance with the invention.

FIG. 7 illustrates a MOKE hysteresis loop for a recording medium constructed in accordance with the invention.

FIG. 8 illustrates a surface plot of auto-correlation signal to noise (ACSN) ratio for a series of recording media constructed in accordance with the invention and having a seedlayer formed of CoCrRu with varying thicknesses and an underlayer formed of Ru and having varying thicknesses.

FIG. 9 illustrates a recording spectrum for a recording medium constructed in accordance with the invention.

### DETAILED DESCRIPTION OF THE INVENTION

The invention provides a thin film magnetic structure. The invention is particularly suitable for use with a perpendicular magnetic recording medium of a magnetic disc storage system

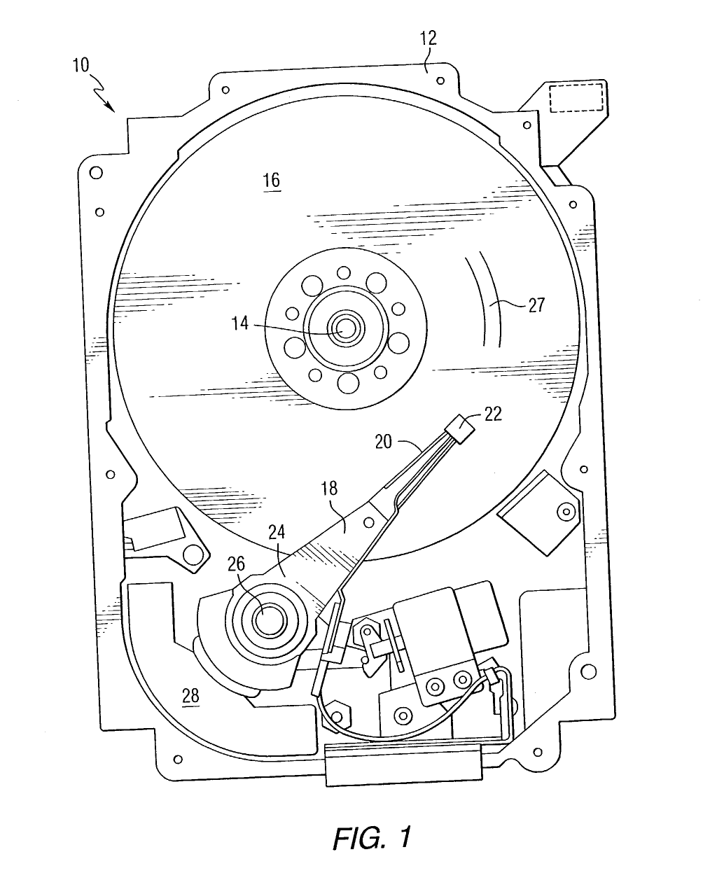

FIG. 1 is a pictorial representation of a disc drive 10 that can utilize a perpendicular recording medium in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

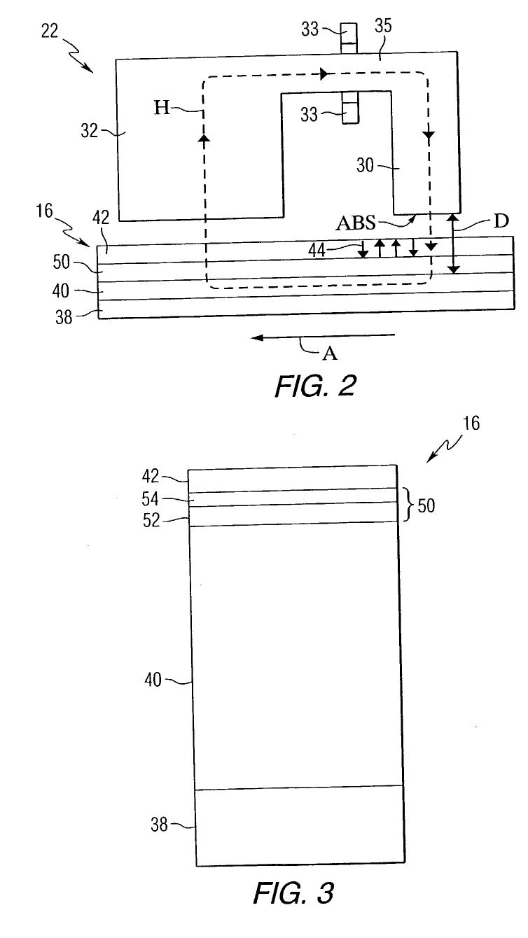

FIG. 2 is a partially schematic side view of a perpendicular magnetic recording head 22 and a perpendicular recording magnetic medium 16. The recording head 22 is well known in the art and includes a writer section comprising a trailing main pole 30 and a return or opposing pole 32. A magnetizing coil 33 surrounds a yoke 35, which connects the main pole 30 and return pole 32. The recording head 22 also may include a reader section (not shown), as is generally known in the art. The reader may include, for example, a conventional GMR reader, MR reader, inductive reader, or the like (not shown) as is also generally known in the art.

Still referring to FIG. 2, the perpendicular magnetic recording medium 16 is positioned under the recording head 22. The recording medium 16 travels in the direction of arrow A during recording. The recording medium 16 includes a substrate 38, which may be made of any suitable material such as ceramic glass, amorphous glass, or NiP plated AlMg. A soft magnetic layer 40 is deposited on the substrate 38. The soft magnetic layer 40 may be made of any suitable material such as FeCoB, CoZrNb or NiFeNb. The soft magnetic layer 40 may have a thickness in the range of about 50 nm to about 500 nm. A hard magnetic recording layer 42, which in this embodiment is a perpendicular recording layer as illustrated by the perpendicular oriented magnetic domains 44, is deposited adjacent to or on an intermediate layer 50 that is formed adjacent to or on the soft magnetic layer 40. Suitable materials for the hard magnetic recording layer 42 may include, for example, CoCrPt, CoCrPtB, Co—Pt alloys, or Co—Pt alloys with oxides such as Co₂O₃, SiO₂, NiO, TiO₂, ZrO₂ or SnO₂. The hard magnetic layer 42 preferably has a hexagonally closed packed (hcp) structure and may have a thickness in the range of about 4 nm to about 20 mm. Although not shown, a protective overcoat, such as a diamond-like carbon, and/or a lubricant layer may be applied over the hard magnetic recording layer 42 as is generally known.

Referring to FIG. 3, an embodiment of the recording medium 16 is illustrated in more detail and, more particularly, an embodiment of the intermediate layer 50 is shown in more detail. The intermediate layer 50 includes a seedlayer 52 formed adjacent to or on the soft magnetic layer 40. The seedlayer may comprise, for example, CoCrRu, CoCr, W, Ta, Mo, Hf, or Ti. The seedlayer 52 may have a thickness in the range of about 1 mm to about 10 nm.

Still referring to FIG. 3, the intermediate layer 50 also includes an underlayer 54 formed between the seedlayer 52 and the hard magnetic recording layer 42. The underlayer 54 may be formed of, for example, Ru or CrRu. The underlayer 54 may have a thickness in the range of about 1 mm to about 10 mm. Thus, with the seedlayer 52 and underlayer 54, the intermediate layer 50 may have a total thickness in the range of about 2 nm to about 20 nm. Advantageously, the intermediate layer 50 constructed in accordance with the invention allows for the formation of the recording medium 16 and, more specifically, for the formation of the hard magnetic recording layer 42 having suitable magnetic properties for perpendicular magnetic recording.

In the design of a perpendicular magnetic recording system, it is important to maintain the spacing between an air-bearing surface (ABS) of the recording head 22 and the soft magnetic layer 40 of the recording medium 16 as small as possible in order to obtain maximum writing field strength and high head field gradient. This spacing is illustrated by arrow D, as shown in FIG. 2. To maintain the spacing D as small as possible, it is important to provide a magnetic recording layer 42 that is as thin as possible and to provide the intermediate layer 50 as thin as possible. For a recording medium 16 constructed in accordance with the invention, the spacing D may be in the range of 10 nm to about 60 nm.

It has been determined that when constructing the hard magnetic recording layer 42 of a Co alloy material that it is difficult to achieve a suitable or well defined (00.2) orientation of the Co alloy on top of a thin intermediate layer due to selective grain growth at the early stage of the film growth. Intermediate layers such as, for example, Ti, TiCr₁₀, TiCr₁₀\CoCr₄₀, CoZr\Ti, TiCr₁₀\CoCr₃₅Ru₁₀, TiCr₁₀\CoCr₂₅Ru₂₅, TiCr₁₀\CoCr₂₀Ru₄₀ are generally known, however, each of these intermediate layers must be relatively thick, e.g., approximately 30 mm, to achieve suitable magnetic properties in the hard magnetic recording layer. As described herein, the intermediate layer 50 of the present invention may be constructed to have a thickness in the range of about 2 nm to about 20 nm while maintaining suitable magnetic properties for the hard magnetic recording layer 42, as will be described in more detail herein.

As an example of the present invention, the recording medium 16 illustrated in FIG. 3 may be as follows: the substrate 38 formed of glass, the soft magnetic layer 40 formed of FeCoB and having a thickness of 200 nm, the seedlayer 52 being formed of CoCrRu and having a thickness of 3 nm, the underlayer 54 being formed of Ru and having a thickness of 1 nm and the hard magnetic recording layer 42 being formed of a CoCrPt alloy and having a thickness of 10 nm. The seedlayer 52 is provided in an amorphous state or other early stage of development of (00.2) orientation. The seedlayer also serves as a wetting layer. Thus, when the underlayer 54 formed of Ru is put on top of the seedlayer 52, the grains like to orient in the (00.2) orientation in the beginning of nucleation and, hence, grow in the same orientation. Since Ru has an hcp structure with very large stacking fault (SF) energy and a good lattice match with CoCrPt, it will form a SF-free surface for the magnetic layer to grow on. As a result, the CoCrPt alloy will grow on top of the Ru epitaxially with less amount of SF's compared with growing on other materials, such as Pt, CoCr, Pd, Au or Ti.

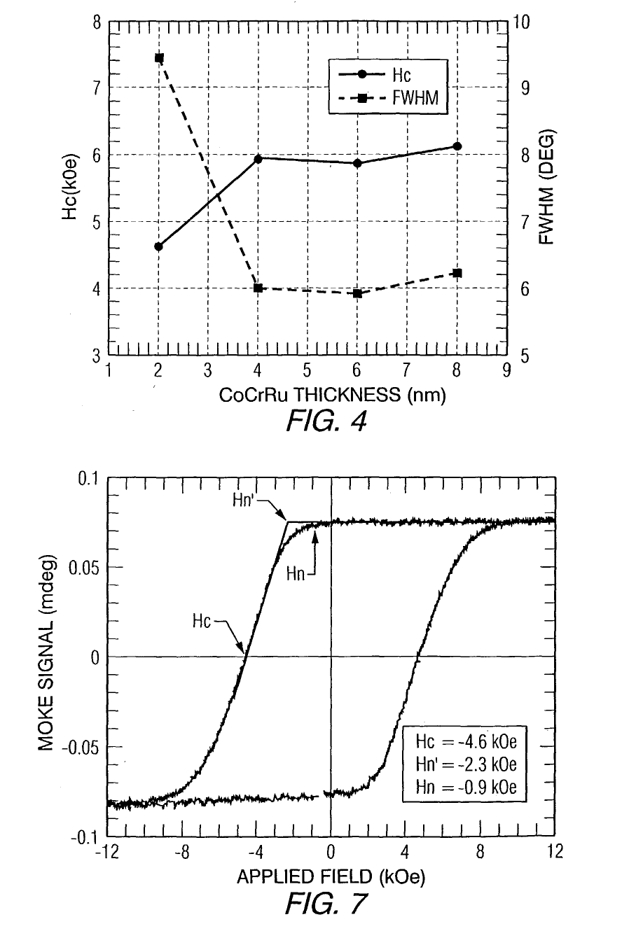

FIG. 4 illustrates a full width at half maximum (FWHM) of X-ray diffraction rocking curve and coercivity (H_{c}) of a magnetic recording layer 42 versus a varying thickness seedlayer 52 formed of CoCrRu. More specifically, the recording medium 16 structure for the results illustrated in FIG. 4 is as follows: glass substrate 38\soft magnetic layer 40 formed of FeCoB with 200 nm thickness\seedlayer 52 formed of CoCrRu with x nm thickness, wherein x=1 . . . 9/underlayer 54 formed of Ru with 2 nm thickness\magnetic recording layer 42 formed of CoCrPt with 11 nm thickness. FIG. 4 illustrates that the FWHM drops rapidly from about 9.5 degrees to about 6.0 degrees when the thickness of the seedlayer 52 increases from about 2 nm to about 4 nm. The FWHM then becomes generally constant as the thickness increases up to about 8 nm. The value of H_{c} increases from about 4.6 kOe to about 5.9 kOe as the seedlayer 52 thickness increases from about 2 nm to about 4 nm. The H_{c} value then remains generally constant as the seedlayer 52 thickness increases up to about 8 nm. These results indicate that a seedlayer 52 formed of CoCrRu having a thickness of about 4 nm can provide complete coverage of the soft magnetic layer 40 and provide suitable wetting and seed effect for the subsequent underlayer 54 formed of Ru. This, in turn, provides for the underlayer 54 to nucleate with a (00.2) orientation instead of being randomly oriented as if the underlayer 54 were deposited directly onto the amorphous soft magnetic layer 40.

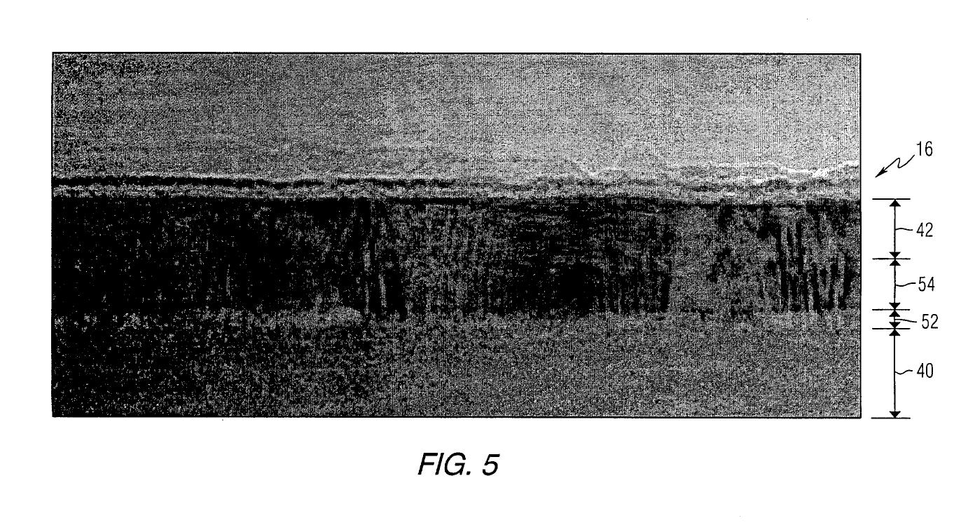

FIG. 5 illustrates a cross-section view of a transmission electron microscopy (TEM) image of a recording medium 16 constructed in accordance with the invention. More specifically, the recording medium 16 structure for the results illustrated in FIG. 5 is as follows: glass substrate 38 (not shown)\soft magnetic layer 40 formed of FeCoB with 200 nm thickness\seedlayer 52 formed of CoCrRu with 2 nm thickness\underlayer 54 formed of Ru with 6 nm thickness\magnetic recording layer 42 formed with CoCrPt with 11 nm thickness. FIG. 5 illustrates that the soft magnetic layer 40 and the seedlayer 52 are in an amorphous state. FIG. 5 further illustrates that the grains of the magnetic layer 42 grow one-on-one on underlayer 54 with the same contrast. This indicates that there is epitaxial growth between the magnetic layer 42 and the underlayer 54.

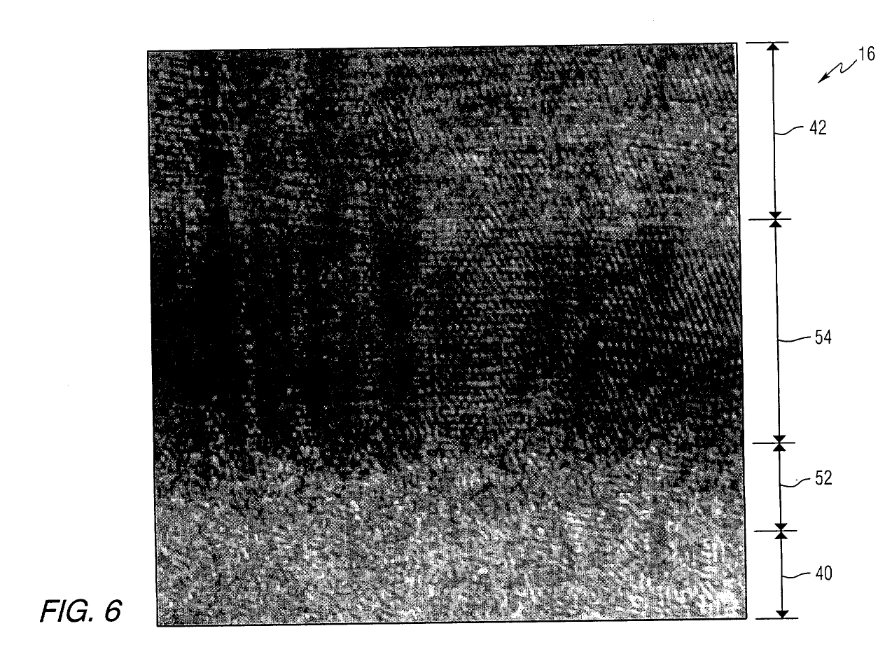

FIG. 6 illustrates a cross-section view of a high resolution TEM image of a recording medium 16 constructed in accordance with the invention. More specifically, the recording medium 16 structure for the results illustrated in FIG. 6 is as follows: glass substrate 38 (not shown)\soft magnetic layer 40 formed of FeCoB with 200 nm thickness (only a top portion is shown)\seedlayer 52 formed of CoCrRu with 2 nm thickness\underlayer 54 formed of Ru with 6 nm thickness\magnetic recording layer 42 formed with CoCrPt with 11 nm thickness. FIG. 6 illustrates that the soft magnetic layer 40 and the seedlayer 52 are in an amorphous state. FIG. 6 further illustrates that the grains of the underlayer 54 nucleate in (00.2) orientation at the initial thickness. This is primarily due to the wetting and the hcp seeding effect of the seedlayer 52. FIG. 6 also illustrates that there is a perfect lattice match between the underlayer 54 and magnetic layer 42 lattices. FIG. 6 also illustrates that there is a very small amount of SF's in the underlayer 52. Thus, the magnetic layer growing on top of the underlayer may have less SF's as well. The underlayer 54, by nucleating in (00.2) orientation at the initial growth thickness, establishes the desired crystalline at very low thickness with few SF's and a better lattice match. For example, this illustrates that the thickness of the underlayer 54 may be as low as about 1 nm.

FIG. 7 illustrates a MOKE hysteresis loop for a recording medium 16 constructed in accordance with the invention and having the following structure: a glass substrate 38\soft magnetic layer 40 with 200 nm thickness\seedlayer 52 formed of CoCrRu with 3 nm thickness\underlayer 54 formed of Ru with 1 nm thickness\hard magnetic recording layer 42 formed of a Co alloy with 10 nm thickness\and a carbon overcoat with 3.5 nm thickness formed on the hard magnetic recording layer 42. FIG. 7 provides the following values of magnetic properties: H_{c}=−4.6 kOe, nucleation field Hₙ′=−0.9 kOe, and effective nucleation field Hₙ=−2.3 kOe. The definition of the nucleation field Hₙ is the reverse field strength that causes the magnetization to drop to about 98% of saturation magnetization Mₛ. The effective nucleation field Hₙ′ is obtained by intercepting the saturation magnetization level and the tangent to the hysteresis loop at H_{c}. FIG. 7 confirms that with such a thin IL (4 nm), a magnetic layer 42 of 10 nm can be grown with desirable magnetic properties, such as sufficient Hc, full squareness (S), and high negative nucleation field (Hₙ and Hₙ′). These properties are essential for perpendicular magnetic recording.

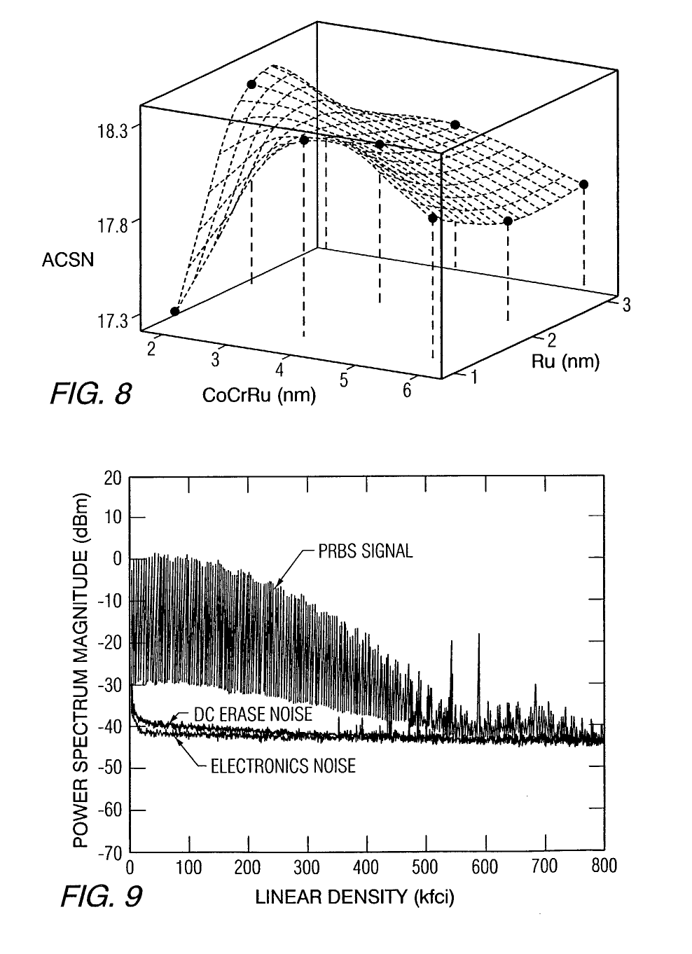

FIG. 8 illustrates a surface plot of the auto-correlation signal to noise (ACSN) ratio for a series of recording media 16 constructed in accordance with the invention and having a seedlayer 52 formed of CoCrRu with varying thicknesses and an underlayer 54 formed of Ru and having varying thicknesses. Specifically, FIG. 8 illustrates that the surface peaks are at CoCrRu (2 nm)/Ru (2 nm) and CoCrRu (4 nm)/Ru (1 nm). This is because if the intermediate layer 50 that comprises the seedlayer 52 and underlayer 54 is formed too thin, the result will be poor orientation of the hard magnetic recording layer 42 which, in turn, results in poor magnetics and recording performance. The results of FIG. 8 also illustrate that if the intermediate layer 50 is too thick, then the result will be larger grain size and poor writing capability due to a large spacing D between the recording head 22 and the soft magnetic layer 40, as described herein.

FIG. 9 illustrates a recording spectrum for a recording medium 16 constructed in accordance with the invention and specifically having a seedlayer 52 formed of CoCrRu with a thickness of 3 nm and an underlayer 54 formed of Ru with a thickness of 1 nm. A spinstand with writer width=150 nm, head to media spacing=15 nm, rotation speed=5400 rpm, track radius=25 nm, minimum bit length=100 nm was used to obtain a pseudo-random bit sequence (PRBS). The auto-correlation signal to noise (ACSN) ratios are determined from the autocorrelation of successive periods of a PRBS signal with the electronics noise removed. All signals were captured from an oscilloscope at a sampling rate of 1 GSamples/s. The DC noise is obtained by DC-erasing the media before readout. The AC noise is obtained by recording a sufficiently high frequency tone before readout (>1000 kilo-flux change per inch (kFCI). The pulse width, PW50, is also obtained from the PRBS signal. The recording spectrum shows low DC erase noise, which is nearly indistinguishable from the electronic noise floor which is expected for high squareness and negative nucleation field of the recording medium 16 with a well formed soft magnetic layer 40. The narrow PW50 and high ACSN calculated based on the spectrum indicate that the media is a good candidate for the higher density recording.

The depositing of layers may be done using, for example, ion beam deposition, DC magnetron sputtering or RF sputtering or other known deposition techniques.

Whereas particular embodiments of the invention have been described herein for the purpose of illustrating the invention and not for purpose of limiting the same, it will be appreciated by those of ordinary skill in the art that numerous variations of the details, materials, and arrangements of parts may be made within the principle and scope of the invention without departing from the invention as described herein and in the appended claims.

What is claimed is:

1. A perpendicular magnetic recording medium, comprising:
a hard magnetic recording layer;
a soft magnetic layer; and
a non-magnetic intermediate layer between said hard magnetic recording layer and said soft magnetic layer, said non-magnetic intermediate layer comprising:
a seedlayer formed adjacent said soft magnetic layer; and
an underlayer formed between said seedlayer and said hard magnetic recording layer, said underlayer comprising Ru or CrRu.

2. The recording medium of claim 1, wherein said seedlayer comprises CoCrRu, CoCr, W, Ta, Mo, Hf or Ti.

3. The recording medium of claim 1, wherein said seedlayer has a thickness in the range of about 1 nm to about 10 nm.

4. The recording medium of claim 1, wherein said underlayer has a thickness in the range of about 1 nm to about 10 nm.

5. The recording medium of claim 1, wherein said non-magnetic intermediate layer has a thickness in the range of about 2 nm to about 20 nm.

6. The recording medium of claim 1, wherein said hard magnetic recording layer comprises a Co alloy material.

7. The recording medium of claim 1, wherein said hard magnetic recording layer has a thickness in the range of about 4 nm to about 20 nm.

8. The recording medium of claim 1, wherein said soft magnetic layer has a thickness in the range of about 50 nm to about 500 nm.

9. The recording medium of claim 1, wherein said soft magnetic layer comprises FeCoB, CoZrNb or NiFeNb.

10. A magnetic disc drive storage system, comprising:
a magnetic recording head having an air bearing surface; and
a perpendicular magnetic recording medium positioned adjacent said air bearing surface of said magnetic recording head, said perpendicular magnetic recording medium comprising a hard magnetic recording layer, a soft magnetic layer and a non-magnetic intermediate layer between said hard magnetic recording layer and said soft magnetic layer, wherein a distance between said air bearing surface of said magnetic recording head and said soft magnetic layer is in the range of about 10 nm to about 60 nm.

11. The system of claim 10, wherein said non-magnetic intermediate layer has a thickness in the range of about 2 nm to about 20 nm.

12. The system of claim 10, wherein said hard magnetic recording layer has a thickness in the range of about 4 run to about 20 nm.

13. The system of claim 10, wherein said non-magnetic intermediate layer comprises:
a seedlayer formed adjacent said soft magnetic layer; and
an underlayer formed between said seedlayer and said hard magnetic recording layer.

14. The system of claim 13, wherein said underlayer comprises Ru or CrRu.

15. The system of claim 13, wherein said seedlayer comprises CoCrRu, CoCr, W, Ta, Mo, Hf or Ti.

16. The system of claim 13, wherein said seedlayer has a thickness in the range of about 1 nm to about 10 nm.

17. The system of claim 13, wherein said underlayer has a thickness in the range of about 1 nm to about 10 nm.

18. A thin film structure, comprising:
a first magnetic layer;
a second magnetic layer; and
a non-magnetic intermediate layer between said first magnetic layer and said second magnetic layer, said non-magnetic intermediate layer including means for inducing a substantially (00.2) orientation in said first magnetic layer.

19. The thin film structure of claim 18, wherein said first magnetic layer comprises a Co alloy material.

20. The thin film structure of claim 18, wherein said means for inducing a substantially (00.2) orientation includes a seedlayer formed adjacent said second magnetic layer, said seedlayer having a substantially hexagonally closed packed crystallographic structure.

21. The thin film structure of claim 20, wherein said seedlayer comprises CoCrRu, CoCr, W, Ta, Mo, Hf or Ti.

22. The thin film structure of claim 20, wherein said means for inducing a substantially (00.2) orientation further includes an underlayer formed between said seedlayer and said first magnetic layer, said underlayer having a substantially hexagonally closed packed crystallographic structure.

23. The thin film structure of claim 22, wherein said underlayer comprises Ru or CrRu.

24. A thin film structure, comprising:
a hard magnetic layer;
a soft magnetic layer; and
a non-magnetic intermediate layer between said hard magnetic layer and said soft magnetic layer, said non-magnetic intermediate layer comprising:
a seedlayer formed adjacent said soft magnetic layer; and
an underlayer formed between said seedlayer and said hard magnetic layer, said underlayer comprising Ru or CrRu.

25. The thin film structure of claim 24, wherein said seedlayer comprises CoCrRu, CoCr, W, Ta, Mo, Hf or Ti.

26. The thin film structure of claim 24, wherein said seedlayer has a thickness in the range of about 1 nm to about 10 nm.

27. The thin film structure of claim 24, wherein said underlayer has a thickness in the range of about 1 nm to about 10 nm.

28. The thin film structure of claim 24, wherein said non-magnetic intermediate layer has a thickness in the range of about 2 nm to about 20 nm.

29. The thin film structure of claim 24, wherein said hard magnetic layer comprises a Co alloy material.

30. The thin film structure of claim 24, wherein said hard magnetic layer has a thickness in the range of about 4 nm to about 20 nm.

31. The thin film structure of claim 24, wherein said soft magnetic layer has a thickness in the range of about 50 nm to about 500 nm.

32. The thin film structure of claim 24, wherein said soft magnetic layer comprises FeCoB, CoZrNb or NiFeNb.
